(19) United States
(12) Patent Application Publication
(10) Pub. No.: US 2026/0161564 A1
(43) Pub. Date: Jun. 11, 2026

(54) METHOD AND APPARATUS TO OPTIMIZE CXL.CACHE ACCESS LATENCY

(71) Applicant: Intel Corporation, Santa Clara, CA (US)

(72) Inventors: Junyuan WANG, Shanghai (CN); Yuan WANG, Nantong (CN); Baoli ZHANG, Beijing (CN); Jianfeng GAO, Shanghai (CN); Furong ZHOU, Beijing (CN)

(21) Appl. No.: 19/426,215

(22) Filed: Dec. 19, 2025

(30) Foreign Application Priority Data
Aug. 28, 2025 (WO) PCT/CN2025/117421

(51) Int. Cl. G06F 12/0831; G06F 13/42

(52) U.S. Cl. CPC G06F 12/0831; G06F 13/4282; G06F 2213/0026

(57) ABSTRACT

Disclosed herein are devices, methods, and system for coherent shared access by a plurality of devices (e.g., a T1/T2 CXL device) to a plurality of cache lines managed by a host (e.g., a home agent that manages the coherent shared access according to a CXL.cache protocol). The host is configured to maintain coherence of at least one target cache line of the plurality of cache lines. The device transmits a warm-up request to the host, where the warm-up request identifies at least one target cache line for prefetching into a local cache of the host. The host, in response to receiving the warm-up request, reads the at least one target cache line from a system memory (e.g., a DRAM that may be external to the host) into a local cache (e.g., a last-level cache (LLC)) of the host.

### CROSS-REFERENCE TO RELATED APPLICATION(S)

This application claims priority to PCT Application No. PCT/CN2025/117421, filed on Aug. 28, 2025, the entire contents of which are incorporated herein by reference.

### BACKGROUND

Compute Express Link (CXL) is one of the latest specifications in interconnect technology for high bandwidth devices, and the term “CXL.cache” refers to a protocol for CXL that was introduced to ensure that CXL devices that are share resources (e.g., CXL Type-1 and CXL Type-2 devices) have a fully coherent local cache such that the data may be held across the components in either a local cache internal to the device or a memory external to the device. CXL.cache utilizes a MESI (modified, exclusive, shared, invalid) coherence protocol in which a home agent (HA), residing in the host processor, is responsible for orchestrating cache coherency and resolving conflicts across multiple caching agents (e.g., CXL devices, local cores, other central processing unit (CPU) sockets, etc.). In certain CXL operations, such as a read operation initiated from a device, data movement from an external memory to the local cache may introduce a latency, causing unacceptable delays, especially when the local cache is small compared to the amount of data that is involved in the operation.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of a two-level (L1 and L2) device cache with prefetch that may be used to reduce access latency in CXL.cache protocols without the need for an increased cache size;

FIG. 2 depicts an example of timing diagram for coherency in a read operation (RdShared) with an access target to L1 device cache;

FIG. 3A illustrates a typical read operation (RdShared) with an access target to L1 device cache for Data0, Data1, and/or Data2;

FIG. 3B shows an improved read operation (RdShared) that prefetches Data0, Data1, and/or Data2 with access targets to L2 device cache that may be performed prior to or simultaneous with an access target to L1 device cache for Data0, Data1, and Data2;

FIG. 4 depicts a state diagram showing use of an existing CXL.cache communication channel that may be used for a warm-up request (e.g., prefetch) and response associated with a two-level CXL.cache; and

FIG. 5 illustrates an exemplary schematic flow diagram of a method for coherent data access in a two-level device CXL.cache with prefetch.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc., where “[ . . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc., where “[ . . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

As used herein, the term “CXL” refers generally to the Compute Express Link Consortium that defines and publishes standards (e.g., the “CXL Specification”, including for example, Revision 3.1, released in November 2023; Revision 3.2, released in December 2024; and Revision 4.0, released in November 2025, etc.) for interconnecting devices such as processors, memory, and accelerators in a memory-coherent manner. The basic idea behind the CXL protocol is to maintain memory coherency as between the central processing unit (CPU) memory space and the attached devices, which allows for resource sharing among the attached devices. “CXL.cache” is an agent coherency protocol that supports device caching of host memory so that CXL devices (e.g., Type-1 and Type-2 devices) may have a fully coherent local cache and the data held across the components in either memory or local cache. CXL.cache is based on a coherence protocol where cache lines may be identified as modified, exclusive, shared, or invalid (MESI: Modified, Exclusive, Shared, Invalid). The Home Agent (HA) is the entity which resides in the host processor and is responsible for orchestrating cache coherency and resolving conflicts across multiple caching agents (CXL devices, local cores, other CPU sockets, etc.).

As noted above, certain CXL operations, such as a read-shared operation (RdShared) initiated from a device, may involve data movement from an external memory to the local cache. This movement of data from an external memory to the local cache may introduce a latency in the operation, causing unacceptable delays, especially when the local cache is small compared to the amount of data that is involved in the operation. Using a read-shared operation as an example, where a device may request a current copy of given cache (e.g., a cache line) from the coherence home (e.g., the home agent/last level cache host) that is responsible for that given cache. If the given cache line needs to be obtained from an external memory (e.g., a dynamic random access memory (DRAM)), then the home agent must first issue a read command to the external memory to pull the data from the memory into its local cache (e.g., its last-level cache or “LLC”). This external read phase generally contributes the largest amount of latency for the overall response to read request. For example, a home agent may require on the order of 100 ns to read data from the memory into its LLC whereas the read request itself (from the device to the home agent) and the response itself (from the home agent to the device) may each only require on the order of a 25 ns. This latency problem may be compounded when a large amount of data is requested from the home agent because the home agent may need to read the data from the external memory in multiple loops when the size of the data requested exceeds the available space in the LLC of the home agent.

As should be understood, the LLC of a home agent may be increased so as to minimize the number of instances where the home agent would need to obtain a given cache line from external memory (i.e., a larger LLC means that fewer loops would be needed or that more clean data may be maintained at the home agent so that reliance on external memory space is reduced. However, a local cache is generally a more expensive resource as compared to external memories, so increasing the size of the local cache may add significant costs to the device.

Using the read operation (RdShared) as an example of a typical data access operation in a CXL.cache protocol, a device may request a cache line from a Home Agent (HA), and it is the HA that ultimately that provides the requested cache line to the requesting device. The HA then manages the request, ensuring, unbeknownst to the device, that a valid copy of the cache line is provided to the device. The device does not need to know how (or from whom) the HA obtained the valid copy. If the HA does not have a valid copy, either because the requested cache line is not in the local cache (LLC) of the Home Agent (this missing data is also called a “miss”) or because its LLC copy is not current and the external memory contains the current copy, the Home Agent performs a read operation to the external memory to obtain the cache line and store it in the Home Agent's LLC. Simply put, if there is a “miss” in the HA for the requested cache line and the external memory contains the current copy, the Home Agent performs a read operation to the external memory and put the read cache line into its LLC. The HA then provides the device with the cache line read out from its (now updated) LLC.

As noted above, the HA may require on the order of 100 ns to read data from the memory (typically a DRAM) into its LLC whereas the read request itself (e.g., RdShared sent from the device to the HA) and the response thereto (data sent from the HA to the device) may each only require on the order of a 25 ns. This latency problem may be compounded when a large amount of data is requested from the HA because it may need to read the data from the external memory in multiple loops when the size of the data requested exceeds the available space in the HA's LLC. For example, if the HA's LLC is only 1 MB (which is a typical cache size), a CXL.cache data access operation that is larger than 1 MB will require multiple loops of external data requests from the HA to the external memory.

To overcome this potential problem with CXL.cache access latency, disclosed herein is a two-level device cache that may help reduce access latency in a CXL.cache protocol. This architecture may reduce data access latency without the additional costs associated with, for example, larger cache sizes, and may thus be better for overall service performance.

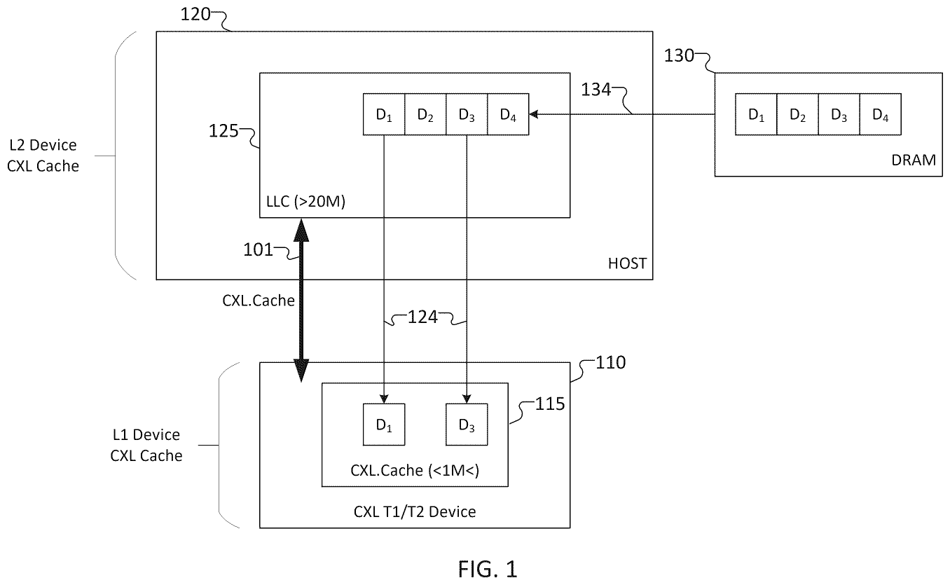

FIG. 1 provides an example of a two-level device cache enhancement to the CXL.cache protocol that may help reduce access latency. Device 110 may be utilizing CXL.cache resources managed by a host 120 or home agent (HA), and in this sense, device 110 may be understood as a CXL T1 or T2 device using a CXL.cache protocol 101. The host 120 may have a lowest-level cache (LLC 125) that may communicate with an external memory 130 (e.g., a DRAM with exemplary set of data bits D1, D2, D4, and D4) when the LLC needs to obtain (via external read operation 134) a current copy of the data and the external memory contains the current copy. Device 110 reads data into its local cache (LLC 115) from the LLC 125 of host 120. In the example of FIG. 1, device 110 will read (in local read operation 124) D1 and D3 from LLC 125 into D1 and D3 of LLC 115 of device 110. In the two-level device cache enhancement, the LLC 115 of the device is understood as a first level device cache (L1) and the LLC 125 of the host 120 is understood as a second level device L2 cache. Though the LLCs may be any size, a typical value for the LLC 125 of the host 120 is upwards of 20 megabytes and a typical value for the LLC 125 of device 110 is 1 megabyte or less. A key aspect of the two-level device cache enhancement is that the external read operation 134 may be done as part of a prefetch or warm-up operation that occurs before the local read operation 124.

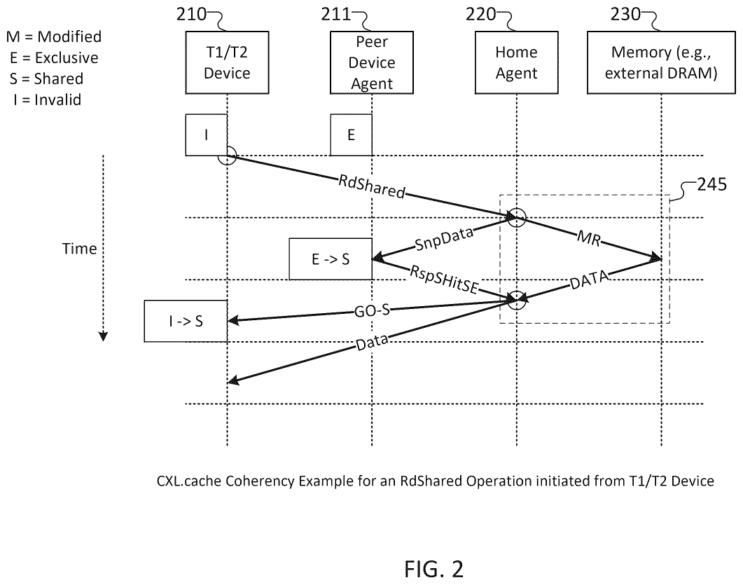

In order to provide a functional example of the disclosed two-level cache, the description below uses the read shared operation (RdShared in the CSX standard) as an exemplary data operation. As should be understood, the disclosed two-level cache is not limited to the RdShared operation and is applicable to any CXL.cache operation in which data is requested (e.g., from a home agent). Reference is made to FIG. 2, which depicts and annotated version of the CXL.cache RdShared operation, with time plotted on the Y-axis, increasing from the top downward, and various CXL devices separated across the X-axis, including T1/T2 device 210, peer device agent 211, home agent 220, and memory 230 (e.g., a DRAM, external to the home agent 220). The various states of a given data is annotated with states from the MESI definition noted above, where I=invalid, E=exclusive, and S=shared. Box 245 shows an external read operation where the home agent 220 sends a memory read (MR) request to the memory 230 in order to obtain a current value of the data from memory 230 into the LLC of the home agent 220.

When T1/T2 device 110 makes a RdShared request, a level two (L2) cache warm-up operation (not depicted in FIG. 2) may be initiated from another device (e.g., peer device agent 211), and according to the existing CXL.cache protocol for cache coherence, the cache status is managed by a HA. In other words, the prefetched caches lines' status may change to invalid (I) from shared (S), based on whether peer device agent 211 (which could be a host or a device) has changed the value of the data. If this is the case, the two-level cache architecture may, via the level one (L1) cache reading, refresh L2 with a full data movement flow from memory 230 to L2 (box 245) and then from L2 to L1: DRAM→L2→L1. To define this cache warm-up operation (also called a prefetch operation), the two-level cache architecture may utilize an opcode to flag an L2 “warm-up”/“prefetch” request.

The CXL.cache protocol currently defines a set of opcodes in Table 3-22 (with reference to the CXL Specification in Revision 3.1) under “Device to Host Requests.” The opcode may be added as a new opcode that expands on the existing list of opcodes so as to flag an L2 “warm-up”/“prefetch” request. The new opcode may be any value that is different from the already-defined values in Table 3-22. One example of such an opcode that may be used to flag an L2 cache warm-up is shown below. As should be understood, this is merely one example, and any opcode that is different from the already-defined values in Table 3-22 may be used to flag such an L2 cache warm-up/prefetch request.

| CXL.cache Opcode | Sematic | Opcode |
|---|---|---|
| CacheWarmup | Read0 (i.e., message without return data) | 1 0001 |

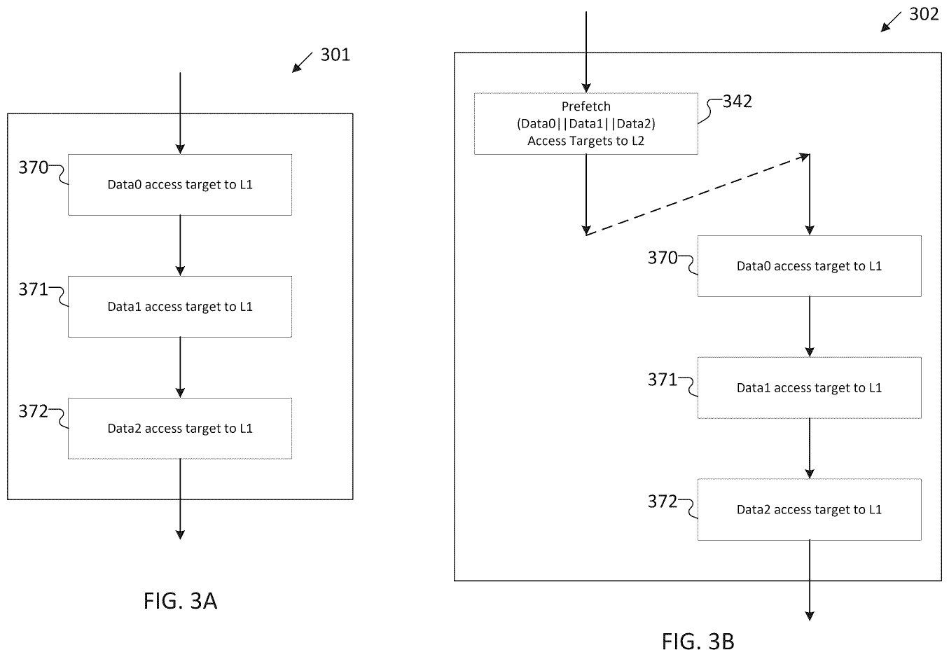

The new opcode may then be used to trigger a prefetching workflow, according to the disclosed two-level cache, that reads data from the external memory into L2. This additional prefetching is shown in FIG. 3B as prefetch 342 in workflow 302. FIG. 3A shows a workflow 301 of read operation, such as RdShared, according to the current CXL.cache protocol without the disclosed two-level cache. After the prefetch 342, the data is read into L1 as in the current CXL.cache protocol with Data0 access target to L1 (370), Data1 access target to L1 (371), and Data2 access target to L1 (372).

In addition to the new opcode, the CXL.cache request/response payload definition of the CXL.cache protocol may be expanded to include the target cache line(s) that are to be prefetched. The CXL.cache protocol currently defines the request/response payload in the CXL Specification in Table 3-13: “CXL.cache-D2H Request Fields” (with reference to the CXL Specification in Revision 3.1 and the device-to-host (D2H) fields and opcodes). Given that there are unused bits, the currently used fields need not be changed (e.g., target cache line base address, etc.) and one or more bits of the non-used “reserved” bits (e.g., the row labeled RSVD in Table 3-13) may be used to store the number of cache lines that are to be read into the L2 cache.

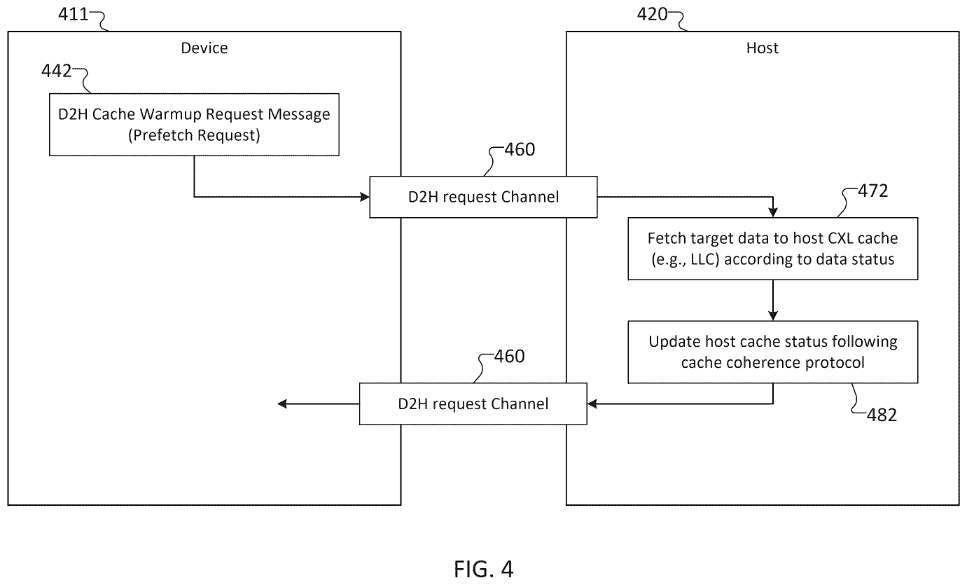

In order to communicate the prefetching workflow, the request/response for fetching target data to host CXL cache according to the data status may use the CXL.cache communication channel currently defined in the protocol. An example of this is depicted in FIG. 4, which shows a device 411 (such as a general processing unit, field-programmable gate array, or other processing device) may issue a CXL.cache request that includes a cache warm-up/prefetch request 442 (e.g., a D2H CacheWarmup opcode, using the example notation discussed above) to a home agent (such as host 420). The cache warm-up/prefetch request 442 may be communicated from the device to the host over D2H request channel 460 and, in response, host 420 may update host cache status back over request channel 460. As should be appreciated, device 411 may issue the prefetch request based on any type of trigger and according to type of data access requirement. It should be understood that the need for the request may not be immediately apparent to the requesting device and it may involve some aspect of speculation/prediction for whether the data will be accessed.

In terms of sequencing on the device side, device 411 may issue a warm-up request to the host 420 (L2) first and then subsequently read the data from the host 420 to the device 411 (L1). Alternatively, device 411 may issue a warm-up request to the host 420 (L2) and simultaneously read the data from the host 420 to the device 411 (L1) (e.g., in parallel).

On the host side, host 420 may be configured to recognize receipt of the cache warm-up/prefetch request 442 so that it may perform the cache warm-up. When the host receives a CacheWarmup request from device 411, host 420 may choose the best option for the type of data prefetch (e.g., sequentially for consecutive cache lines, a block read, etc.) in order to fetch (in 427) the data into its LLC (e.g., when appropriate, from an external the memory (e.g., the DRAM)). Then, host 420 may update (at 482) the host cache status as appropriate, according to the CXL.cache coherence protocol. Importantly, the host does not need to return the data itself to device 411 (e.g., to put the data in the device's L1 cache). Instead, host 420 need only return the L2 data warm-up status to device 411, and device 411 is responsible for handling the result/error appropriately.

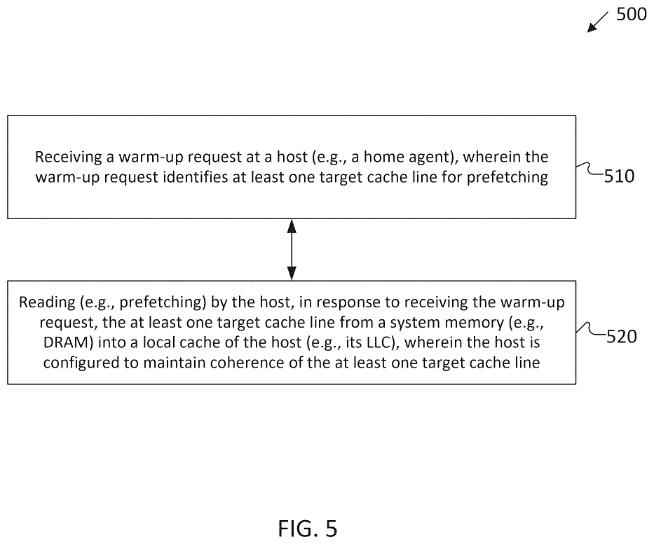

FIG. 5 illustrates a schematic flow diagram of a method 500 for coherent data access in a two-level device CXL.cache with prefetch. Method 500 may implement any of the features discussed above with respect to the adaptive wind-based controller system and/or FIGS. 1-4. Method 500 includes, in 510, transmitting a warm-up request to a host (e.g. a home agent), wherein the warm-up request identifies at least one target cache line for prefetching. Method 500 also includes, in 520, reading (e.g., prefetching) by the host, in response to receiving the warm-up request, the at least one target cache line from a system memory (e.g., a DRAM) into a local cache of the host (e.g., its last-level cache (LLC)), wherein the host is configured to maintain coherence of the at least one target cache line.

In the following, various examples are provided that may include one or more aspects described with reference to coherent data access in a two-level device CXL.cache with prefetch discussed above and/or any of FIGS. 1-5. The examples provided in relation to the devices may apply also to the described method(s), and vice versa.

Example 1 is a method including receiving a warm-up request at a host, wherein the warm-up request identifies at least one target cache line for prefetching. The method also includes reading (prefetching) by the host (e.g., a home agent), in response to receiving the warm-up request, the at least one target cache line from a system memory (e.g., DRAM) into a local cache of the host (e.g., last-level cache (LLC)), wherein the host is configured to maintain coherence of the at least one target cache line.

Example 2 is the method of example 1, wherein the warm-request is from a device that is one of a plurality of devices configured to share the at least one target cache line according to a Compute Express Link (CXL) coherence protocol.

Example 3 is the method of any one of examples 1 to 2, wherein the warm-up request is received over a Compute Express Link cache (CXL.cache) link between a device and the host, wherein the host is configured to maintain the coherence of the at least one target cache line for a plurality of devices that share the at least one target cache line, wherein the device is one of the plurality of devices.

Example 4 is the method of any one of examples 1 to 3, wherein the host is configured as a home agent of a Compute Express Link cache protocol to maintain coherence of the at least one target cache line.

Example 5 is the method of any one of examples 1 to 4, the method further including transmitting a response that indicates a status of the coherence of the at least one target cache line.

Example 6 is the method of example 5, wherein the host is configured to maintain the coherence of the at least one target cache line for a plurality of devices that share the at least one target cache line, wherein the device is one of the plurality of devices, wherein transmitting the response includes transmitting the response to another one of the plurality of devices that is different from the device.

Example 7 is the method of any one of examples 5 to 6, wherein the warm-up request includes a transaction code specifying a status-only response.

Example 8 is the method of any one of examples 1 to 7, wherein the local cache is a last-level cache that is local to the host.

Example 9 is the method of any one of examples 1 to 8, wherein the warm-up request includes a transaction code specifying a status-only response.

Example 10 is the method of any one of examples 1 to 9, the method further including transmitting, by the host, a completion status for the warm-up request.

Example 11 is the method of example 10, wherein the transmitting the completion status includes transmitting the completion status over a CXL.cache response channel.

Example 12 is the method of any one of examples 1 to 11, wherein the system memory is external to the host (e.g., a DRAM).

Example 13 is the method of any one of examples 1 to 12, the host is configured to maintain CXL coherence of the local cache without returning to the device a data value of the at least one target cache line.

Example 14 is the method of any one of examples 1 to 13, wherein the warm-up request that identifies the at least one target cache line includes the warm-up request encoded as a CXL.cache (Read0) device-to-host opcode having a status-only response format.

Example 15 is the method of any one of examples 1 to 14, the method further including sourcing, by the host, the at least one target cache line from the local cache based on a coherency state of the at least one target cache line.

Example 16 is the method of any one of examples 1 to 15, wherein the warm-up request includes a base address for the at least one target cache line and a field encoding a count of additional cache lines for prefetching that are in addition to the at least one target cache line.

Example 17 is the method of example 16, wherein the count of the additional cache lines is encoded in a request field of a device-to-host CXL.cache request.

Example 18 is the method of example 16, wherein the reading includes a block prefetch into the local cache based on a base address, wherein the count of additional cache lines represents a contiguous cache-line range for the additional cache lines to read (for the prefetching).

Example 19 is device including a means for receiving a warm-up request at a host, wherein the warm-up request identifies at least one target cache line for prefetching. The device also includes a means for reading (prefetching) by the host (e.g. a home agent), in response to receiving the warm-up request, the at least one target cache line from a system memory into a local cache, wherein the host is configured to maintain coherence of the at least one target cache line.

Example 20 is the device of example 19, wherein the means for receiving the warm-up request is configured to receive the warm-up request from a device that is one of a plurality of devices configured to share the at least one target cache line according to a Compute Express Link (CXL) coherence protocol.

Example 21 is the device of any one of examples 19 to 20, wherein the means for receiving the warm-up request is configured to receive the warm-up request over a Compute Express Link cache (CXL.cache) link between a device and the host, wherein the host is configured to maintain the coherence of the at least one target cache line for a plurality of devices that share the at least one target cache line, wherein the device is one of the plurality of devices.

Example 22 is the device of any one of examples 19 to 21, the device further including a means for transmitting a response that indicates a status of the coherence of the at least one target cache line.

Example 23 is the device of any one of examples 19 to 22, wherein the host is configured as a home agent of a Compute Express Link cache protocol to maintain coherence of the at least one target cache line.

Example 24 is the device of example 23, wherein the means for transmitting the response includes a means for transmitting the response to another one of the plurality of devices that is different from the device.

Example 25 is the device of any one of examples 23 to 24, wherein the warm-up request includes a transaction code specifying a status-only response.

Example 26 is the device of any one of examples 19 to 25, wherein the local cache is a last-level cache that is local to the host.

Example 27 is the device of any one of examples 19 to 26, wherein the warm-up request includes a transaction code specifying a status-only response.

Example 28 is the device of any one of examples 19 to 27, the device further including a means for transmitting, by the host, a completion status for the warm-up request.

Example 29 is the device of example 28, wherein the means for transmitting the completion status includes a means for transmitting the completion status over a CXL.cache response channel.

Example 30 is the device of any one of examples 19 to 29, wherein the system memory is external to the host (e.g., wherein the system memory is a dynamic random access memory (DRAM) coupled to the host).

Example 31 is the device of any one of examples 19 to 30, the host is configured to maintain CXL coherence of the local cache without returning to the device a data value of the at least one target cache line.

Example 32 is the device of any one of examples 19 to 31, wherein the warm-up request that identifies the at least one target cache line includes the warm-up request encoded as a CXL.cache (Read0) device-to-host opcode having a status-only response format.

Example 33 is the device of any one of examples 19 to 32, the device further including a means for sourcing, by the host, the at least one target cache line from the local cache based on a coherency state of the at least one target cache line.

Example 34 is the device of any one of examples 19 to 33, wherein the warm-up request includes a base address for the at least one target cache line and a field encoding a count of additional cache lines for prefetching in addition to the at least one target cache line.

Example 35 is the device of example 34, wherein the count of the additional cache lines is encoded in a request field of a device-to-host CXL.cache request.

Example 36 is the device of example 34, wherein the means for reading includes a means for block prefetching into the local cache based on a base address, wherein the count of additional cache lines represents a contiguous cache-line range for the additional cache lines to read (prefetch).

Example 37 is a system for coherent shared access by a plurality of devices (e.g., a T1/T2 CXL device) to a plurality of cache lines managed by a host (to manage the coherent shared access by the plurality of devices according to the plurality of cache lines according to a CXL.cache protocol), the system including: a device of the plurality of devices configured to transmit a warm-up request to the host, wherein the warm-up request identifies at least one target cache line for prefetching into a local cache of the host. The system also includes the host, wherein the host is configured to read by the host (e.g., a home agent), in response to receiving the warm-up request, the at least one target cache line from a system memory (e.g., a DRAM that may be external to the host) into a local cache (last-level cache (LLC)) of the host, wherein the host is configured to maintain coherence of the at least one target cache line.

Example 38 is the system of example 37, wherein the device is a T1 or T2 Compute Express Link (CXL) device, wherein the coherent shared access is defined by a CXL coherence protocol.

Example 39 is the system of any one of examples 37 to 38, wherein the device is configured to transmit the warm-up request over a Compute Express Link cache (CXL.cache) link between the device and the host, wherein the host is configured to maintain the coherence of the at least one target cache line for the plurality of devices.

Example 40 is the system of any one of examples 37 to 39, wherein the host is configured as a home agent of a Compute Express Link cache protocol to maintain coherence of the at least one target cache line.

Example 41 is the system of any one of examples 37 to 40, wherein the host is configured to transmit a response that indicates a status of the coherence of the at least one target cache line.

Example 42 is the system of example 41, wherein the host configured to transmit the response includes the host configured to transmit the response to another one of the plurality of devices that is different from the device.

Example 43 is the system of any one of examples 41 to 42, wherein the warm-up request includes a transaction code specifying a status-only response.

Example 44 is the system of any one of examples 37 to 43, wherein the warm-up request includes a transaction code specifying a status-only response.

Example 45 is the system of any one of examples 37 to 44, wherein the host is further configured to transmit, by the host, a completion status for the warm-up request.

Example 46 is the system of example 45, wherein the host is further configured to transmit the completion status over a CXL.cache response channel.

Example 47 is the system of any one of examples 37 to 46, wherein the system memory is external to the host (e.g., a DRAM coupled to the host).

Example 48 is the system of any one of examples 37 to 47, wherein the host is configured to maintain CXL coherence of the local cache without returning to the device a data value of the at least one target cache line.

Example 49 is the system of any one of examples 37 to 48, wherein the warm-up request that identifies the at least one target cache line includes the warm-up request encoded as a CXL.cache (Read0) device-to-host opcode having a status-only response format.

Example 50 is the system of any one of examples 37 to 49, wherein the host is further configured to source the at least one target cache line from the local cache based on a coherency state of the at least one target cache line.

Example 51 is the system of any one of examples 37 to 50, wherein the warm-up request includes a base address for the at least one target cache line and a field encoding a count of additional cache lines to for prefetching in addition to the at least one target cache line.

Example 52 is the system of example 51, wherein the count of the additional cache lines is encoded in a request field of a device-to-host CXL.cache request.

Example 53 is the system of example 51, wherein the reading includes a block prefetch into the local cache based on a base address, wherein the count of additional cache lines represents a contiguous cache-line range for the additional cache lines to read (prefetch).

Example 54 is an apparatus including a memory with instructions stored thereon and a processor coupled to the memory, wherein the processor is configured, based on the instructions, to cause a host (e.g., a home agent) to receive a warm-up request from a device, wherein the warm-up request identifies at least one target cache line for prefetching. The processor is also configured to cause the host to read (prefetch), in response to receiving the warm-up request, the at least one target cache line from a system memory (e.g., DRAM) into a local cache (e.g., last-level cache (LLC)) of the host, wherein the host is configured to maintain coherence of the at least one target cache line.

Example 55 is the apparatus of example 54, wherein the device is one of a plurality of devices configured to share the at least one target cache line according to a Compute Express Link (CXL) coherence protocol.

Example 56 is the apparatus of any one of examples 54 to 55, wherein the processor is configured to cause the host to receive the warm-up request from the device over a Compute Express Link cache (CXL.cache) link between the device and the host, wherein the host is configured to maintain the coherence of the at least one target cache line for a plurality of devices that share the at least one target cache line, wherein the device is one of the plurality of devices.

Example 57 is the apparatus of any one of examples 54 to 56, wherein the host is configured as a home agent of a Compute Express Link cache protocol to maintain coherence of the at least one target cache line.

Example 58 is the apparatus of any one of examples 54 to 57, wherein the processor is configured to cause the host to transmit a response that indicates a status of the coherence of the at least one target cache line.

Example 59 is the apparatus of example 58, wherein the device is one of a plurality of devices configured to share the at least one target cache line according to a coherence protocol, wherein the processor is configured to cause the host to transmit the response to another one of the plurality of devices that is different from the device.

Example 60 is the apparatus of any one of examples 58 to 59, wherein the warm-up request includes a transaction code specifying a status-only response.

Example 61 is the apparatus of any one of examples 54 to 60, wherein the local cache is a last-level cache that is local to the host.

Example 62 is the apparatus of any one of examples 54 to 61, wherein the warm-up request includes a transaction code specifying a status-only response.

Example 63 is the apparatus of any one of examples 54 to 62, wherein the processor is further configured to cause the host to transmit a completion status for the warm-up request.

Example 64 is the apparatus of example 63, wherein the processor is further configured to cause the host to transmit the completion status over a CXL.cache response channel.

Example 65 is the apparatus of any one of examples 54 to 64, wherein the system memory is external to the host (e.g., a DRAM).

Example 66 is the apparatus of any one of examples 54 to 65, wherein the processor is configured to cause the host to maintain CXL coherence of the local cache without returning to the device a data value of the at least one target cache line.

Example 67 is the apparatus of any one of examples 54 to 66, wherein the warm-up request that identifies the at least one target cache line includes the warm-up request encoded as a CXL.cache (Read0) device-to-host opcode having a status-only response format.

Example 68 is the apparatus of any one of examples 54 to 67, wherein the processor is further configured to cause the host to source the at least one target cache line from the local cache based on a coherency state of the at least one target cache line.

Example 69 is the apparatus of any one of examples 54 to 68, wherein the warm-up request includes a base address for the at least one target cache line and a field encoding a count of additional cache lines to for prefetching in addition to the at least one target cache line.

Example 70 is the apparatus of example 69, wherein the count of the additional cache lines is encoded in a request field of a device-to-host CXL.cache request.

Example 71 is the apparatus of example 69, wherein the processor is configured to cause the host to read (prefetch) into the local cache using a block prefetch that is based on a base address, wherein the count of additional cache lines represents a contiguous cache-line range for the additional cache lines to read (prefetch).

Example 72 is a non-transitory, computer-readable medium including instructions that, when executed by one or more processors, cause the one or more processors to cause a host (e.g., a home agent) to receive a warm-up request from a device, wherein the warm-up request identifies at least one target cache line for prefetching. The instructions also cause the one or more processors to cause the host to read (prefetch), in response to receiving the warm-up request, the at least one target cache line from a system memory (e.g., DRAM) into a local cache (e.g., last-level cache (LLC)) of the host, wherein the host maintains coherence of the at least one target cache line.

Example 73 is the non-transitory, computer-readable medium of example 72, wherein the device is one of a plurality of devices configured to share the at least one target cache line according to a Compute Express Link (CXL) coherence protocol.

Example 74 is the non-transitory, computer-readable medium of any one of examples 72 to 73, wherein the instructions also cause the one or more processors to cause the host to receive the warm-up request from the device over a Compute Express Link cache (CXL.cache) link between the device and the host, wherein the host is configured to maintain the coherence of the at least one target cache line for a plurality of devices that share the at least one target cache line, wherein the device is one of the plurality of devices.

Example 75 is the non-transitory, computer-readable medium of any one of examples 72 to 74, wherein the host is configured as a home agent of a Compute Express Link cache protocol to maintain coherence of the at least one target cache line.

Example 76 is the non-transitory, computer-readable medium of any one of examples 72 to 75, wherein the instructions further cause the one or more processors to cause the host to transmit a response that indicates a status of the coherence of the at least one target cache line.

Example 77 is the non-transitory, computer-readable medium of example 76, wherein the device is one of a plurality of devices configured to share the at least one target cache line according to a coherence protocol, wherein the instructions cause the one or more processors to cause the host to transmit the response to another one of the plurality of devices that is different from the device.

Example 78 is the non-transitory, computer-readable medium of any one of examples 76 to 77, wherein the warm-up request includes a transaction code specifying a status-only response.

Example 79 is the non-transitory, computer-readable medium of any one of examples 72 to 78, wherein the local cache is a last-level cache that is local to the host.

Example 80 is the non-transitory, computer-readable medium of any one of examples 72 to 79, wherein the warm-up request includes a transaction code specifying a status-only response.

Example 81 is the non-transitory, computer-readable medium of any one of examples 72 to 80, wherein the instructions cause the one or more processors to cause the host to transmit a completion status for the warm-up request.

Example 82 is the non-transitory, computer-readable medium of example 81, wherein the instructions cause the one or more processors to cause the host to transmit the completion status over a CXL.cache response channel.

Example 83 is the non-transitory, computer-readable medium of any one of examples 72 to 82, wherein the system memory is external to the host (e.g., a DRAM).

Example 84 is the non-transitory, computer-readable medium of any one of examples 72 to 83, wherein the instructions cause the one or more processors to cause the host to maintain CXL coherence of the local cache without returning to the device a data value of the at least one target cache line.

Example 85 is the non-transitory, computer-readable medium of any one of examples 72 to 84, wherein the warm-up request that identifies the at least one target cache line includes the warm-up request encoded as a CXL.cache (Read0) device-to-host opcode having a status-only response format.

Example 86 is the non-transitory, computer-readable medium of any one of examples 72 to 85, wherein the instructions cause the one or more processors to cause the host to source the at least one target cache line from the local cache based on a coherency state of the at least one target cache line.

Example 87 is the non-transitory, computer-readable medium of any one of examples 72 to 86, wherein the warm-up request includes a base address for the at least one target cache line and a field encoding a count of additional cache lines for prefetching in addition to the at least one target cache line.

Example 88 is the non-transitory, computer-readable medium of example 87, wherein the count of the additional cache lines is encoded in a request field of a device-to-host CXL.cache request.

Example 89 is the non-transitory, computer-readable medium of example 87, wherein the instructions cause the one or more processors to cause the host to read (prefetch) into the local cache using a block prefetch that is based on a base address, wherein the count of additional cache lines represents a contiguous cache-line range for the additional cache lines to read (prefetch).

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A system comprising:
a device of a plurality of devices that are configured to have coherent shared access to a plurality of cache lines; and
a host configured to manage the coherent shared access to the plurality of cache lines, wherein the device is configured to transmit a warm-up request to the host, wherein the warm-up request identifies at least one target cache line of the plurality of cache lines for prefetching, wherein the host is configured to maintain coherence of the at least one target cache line and, in response to receiving the warm-up request, read the at least one target cache line from a system memory into a local cache of the host.

2. The system of claim 1, wherein the device is configured to transmit the warm-up request over a Compute Express Link cache (CXL.cache) link between the device and the host.

3. The system of claim 1, wherein the device comprises a T1 or T2 Compute Express Link (CXL) device, wherein the coherent shared access is defined by a CXL coherence protocol.

4. The system of claim 1, wherein the host is configured as a home agent of a Compute Express Link cache protocol to manage the coherent shared access to the plurality of cache lines.

5. The system of claim 1, wherein the host is configured to transmit a response that indicates a status of the coherence of the at least one target cache line.

6. The system of claim 5, wherein the host is configured to transmit a response that indicates a status of the coherence of the at least one target cache line.

7. The system of claim 5, wherein the warm-up request comprises a transaction code specifying a status-only response.

8. The system of claim 1, wherein the local cache comprises a last-level cache (LLC) that is local to the host.

9. The system of claim 1, wherein the host is further configured to transmit a completion status for the warm-up request.

10. The system of claim 9, wherein the host is further configured to transmit the completion status over a CXL.cache response channel.

11. The system of claim 1, wherein the system memory is an external memory coupled to the host.

12. The system of claim 1, wherein the warm-up request that identifies the at least one target cache line comprises the warm-up request encoded as a CXL.cache device-to-host opcode having a status-only response format.

13. The system of claim 1, wherein the host is further configured to source the at least one target cache line from the local cache based on a coherency state of the at least one target cache line.

14. The system of claim 1, wherein the warm-up request comprises a base address for the at least one target cache line and a field encoding a count of additional cache lines for prefetching in addition to the at least one target cache line.

15. The system of claim 14, wherein the count of the additional cache lines is encoded in a request field of a device-to-host CXL.cache request.

16. The system of claim 14, wherein the host is configured to read the at least one target cache line via a block prefetch into the local cache based on a base address, wherein the count of additional cache lines represents a contiguous cache-line range for the additional cache lines to prefetch.

17. A method comprising:
receiving a warm-up request at a host, wherein the warm-up request identifies at least one target cache line for prefetching; and
reading by the host, in response to receiving the warm-up request, the at least one target cache line from a system memory into a local cache of the host, wherein the host is configured to maintain coherence of the at least one target cache line.

18. The method of claim 17, wherein the transmitting is over a Compute Express Link cache (CXL.cache) link between a device and the host, wherein the host is configured to maintain the coherence of the at least one target cache line for a plurality of devices that share the at least one target cache line, wherein the device is one of the plurality of devices.

19. A non-transitory, computer-readable medium comprising instructions that, when executed by one or more processors, cause the one or more processors to:
cause a host to receive a warm-up request from a device, wherein the warm-up request identifies at least one target cache line for prefetching; and
cause the host to read, in response to receiving the warm-up request, the at least one target cache line from a system memory into a local cache of the host, wherein the host maintains coherence of the at least one target cache line.

20. The non-transitory, computer-readable medium of claim 19, wherein the host is configured to maintain a coherence status of the at least one target cache line for a plurality of devices that share the at least one target cache line, wherein the device is one of the plurality of devices, wherein the instructions further cause the host to transmit the coherence status to another one of the plurality of devices.
